(19) United States
(12) Patent Application Publication
(10) Pub. No.: US 2022/0150575 A1
(43) Pub. Date: May 12, 2022

(54) SYNCHED MULTIMEDIA NESTED CONTROL DEVICE

(71) Applicant: David W Strain, JR., Mobile, AL (US)

(72) Inventor: David W Strain, JR., Mobile, AL (US)

(21) Appl. No.: 17/093,253

(22) Filed: Nov. 9, 2020

(51) Int. Cl. H04N 21/43; H04N 21/431

(52) U.S. Cl. CPC H04N 21/43072; H04N 21/4316; H04N 21/43074

(57) ABSTRACT

A system and method for seamlessly synching and combining two or more multimedia sources into a new multimedia source is provided. The system generally comprises a computing entity in the form of a control board having a user interface, a processor, a multimedia device operably connected to said computing entity, a display operably connected to said computing entity, and a non-transitory computer-readable medium having instructions stored thereon. In one preferred embodiment, a database may be operably connected to the processor and store any combined multimedia source created by the system within user profiles. The system and method are designed to break multimedia sources into audio and/or video data and allow a user to recombine them into a customized multimedia source.

### FIELD OF THE DISCLOSURE

The subject matter of the present disclosure refers generally to a system and method for seamlessly synching and combining two or more multimedia sources into a new multimedia source.

### BACKGROUND

Large entertainment events covered by the media often have multiple sources from which a viewer may choose. Frequently, the angles from which video is captured differ depending on the source, but the commentary describing the event almost always vastly differs depending on the source. This is particularly true for major sporting events where there may be a single source for video but multiple sources for audio commentary. Reporters at these events who provide the commentary often have their own biases, which may or may not align with the biases of the viewer. This may cause a viewer to stop watching the event all together or at least cause the viewer to reduce the volume until the commentary provided by the reporter can no longer be heard. However, reducing the volume in this way can undoubtedly interfere with the viewer's viewing experience by eliminating sounds that may immerse the viewer in the event. For instance, a viewer who can hear the sound of a baseball hitting a bat or the sound of the crowd cheering after a long touchdown run can enjoy a more immersive experience than a viewer who must view with the sound off to avoid hearing obnoxious commentary.

Additionally, the advent of live streaming social media platforms, such as Twitch and Mixer, has allowed for more live commentary to exist than at any point in history. Currently, there is no way for a user who enjoys the commentary from one of these social media streams to listen to the live stream audio while watching a televised entertainment event without first muting the televised multimedia event on their television and then play the audio on a separate computing device of the live stream in which they want to listen. This can create serious issues with sound/video synchronization since it's very unlikely that the two multimedia sources will be synched in any kind of coherent way. Moreover, this requires the use of more than one device having separate input devices controlling two separate multimedia sources, which unnecessarily complicates the viewing experience. Furthermore, should a viewer want to pause, rewind, or fast forward the broadcast, it would require manipulating both multimedia sources through their respective streaming device to resynch them. And if a viewer should wish to view the broadcast at a later time, it may not be possible to do so if the desired multimedia sources re not saved in a way that would allow the user to synch the desired video and audio components in a way described above.

Accordingly, there is a need in the art for a system and method that may allow a user to combine video data and audio data from two different sources to create a new personalized multimedia source.

### SUMMARY

A system and method for seamlessly integrating controls that allow a user to choose two or more multiple media sources to combine is provided. The system generally comprises a computing entity in the form of a control board having a user interface, a processor, a multimedia device operably connected to said computing entity, a display operably connected to said computing entity, and a non-transitory computer-readable medium having instructions stored thereon. In one preferred embodiment, a database may be operably connected to the processor and store any combined multimedia source created by the system within user profiles. The database may also be used to store user data, such as username, multimedia source preferences, etc. A wireless communication interface (preferably in the form of an antenna) may allow the processor to receive audio data in the form of radio waves or as digital data.

The control board may receive a primary multimedia source from a multimedia device and a secondary multimedia source via a communication interface operably connected to the processor of the control board. The communication interface may be wired or wireless. The control board may then break the primary multimedia source and secondary multimedia source into audio data and video data, and the system may then combine the primary video data with the secondary audio data to create a combined multimedia source. In some embodiments, the system may synch the video data and audio data before combining to create the combined multimedia source. Alternatively, a user may input commands that cause the system to speed up or delay the sound timing and/or video timing until the audio data and video data are in synch. The combined multimedia source may be saved in the database with a user profile, allowing a user to replay the combined multimedia source at a later time.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is a diagram of an example environment in which techniques described herein may be implemented.

FIG. 3 is a diagram of an example environment in which techniques described herein may be implemented.

FIG. 4 is a diagram of an example environment in which techniques described herein may be implemented.

FIG. 5 is a diagram of an example environment in which techniques described herein may be implemented.

FIG. 6 is a diagram of an example environment in which techniques described herein may be implemented.

FIG. 7 is a diagram of an example environment in which techniques described herein may be implemented.

FIG. 8 is a flow chart illustrating certain method steps of a method embodying features consistent with the principles of the present disclosure.

FIG. 9 is a diagram of an example environment in which techniques described herein may be implemented.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of seamlessly integrating controls into a video feed which allows the user to choose two or more media sources to combine.

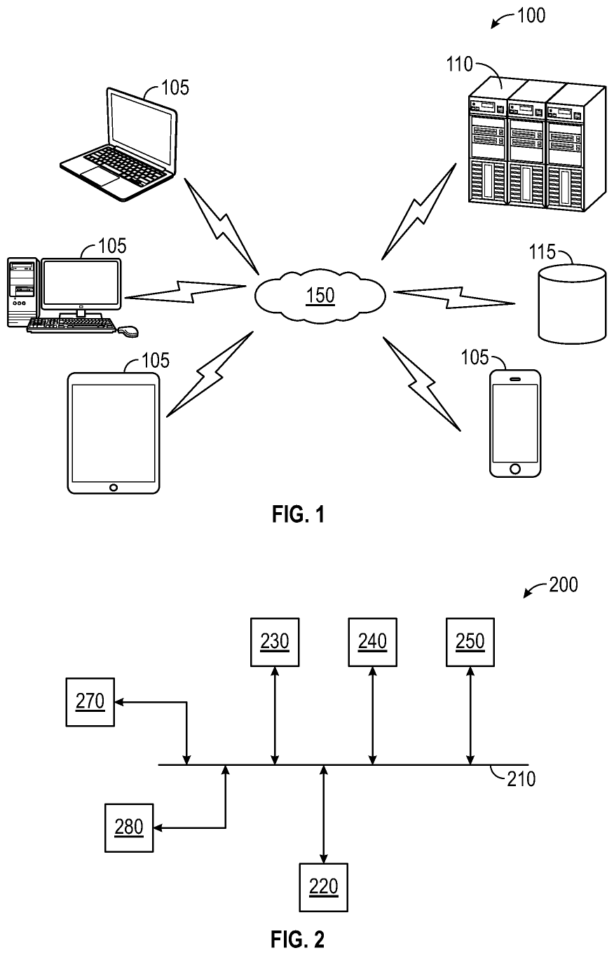

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for example, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for example, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 410, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device 408 and/or an output device 910. As used herein, an input device 408 may be defined as a device that allows a user 405 to input data and instructions that is then converted into a pattern of electrical signals in binary code that are comprehensible to a computing entity 200. An input device 408 of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device 910 may be defined as a device that translates the electronic signals received from a computing entity 200 into a form intelligible to the user 405. An output device 910 of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

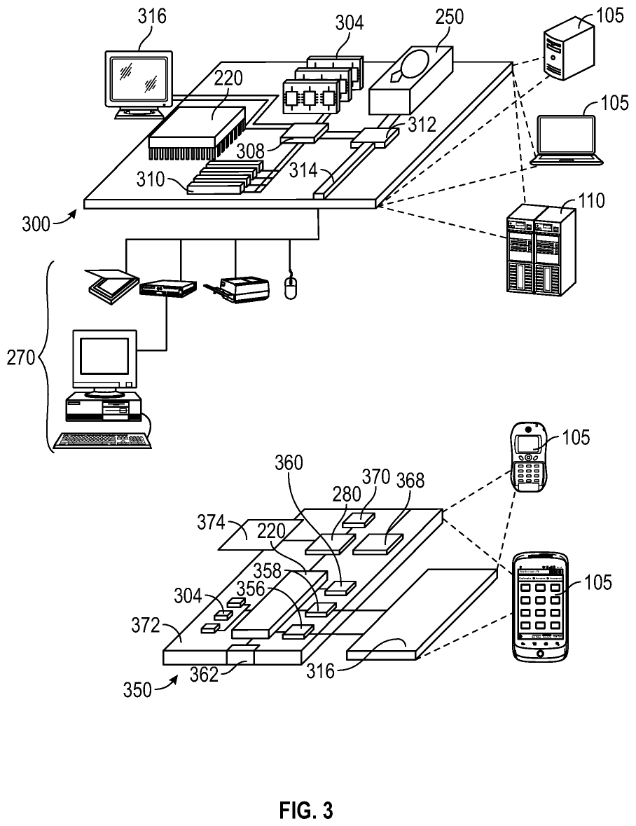

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device 910, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For example, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 410, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the it is not connected to a stationary power outlet or if the stationary power outlet ceases to provide power to the computing entity 200.

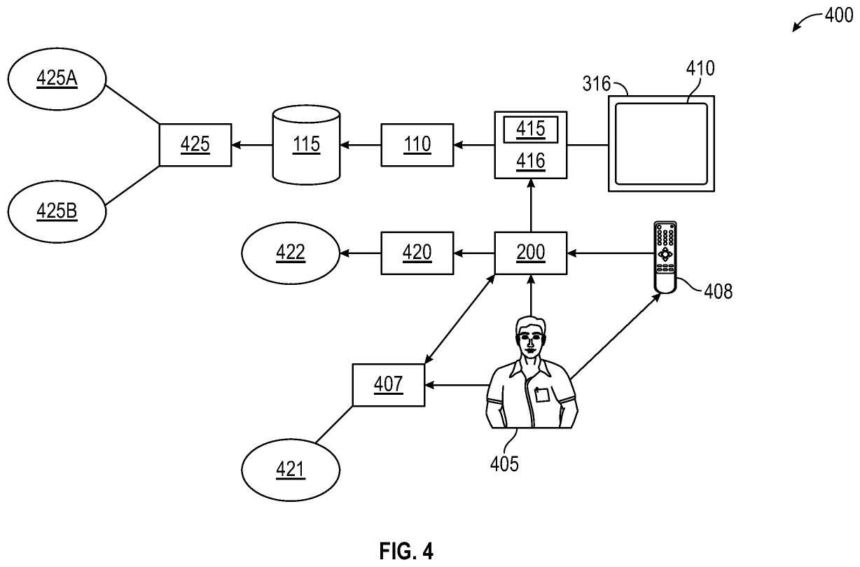

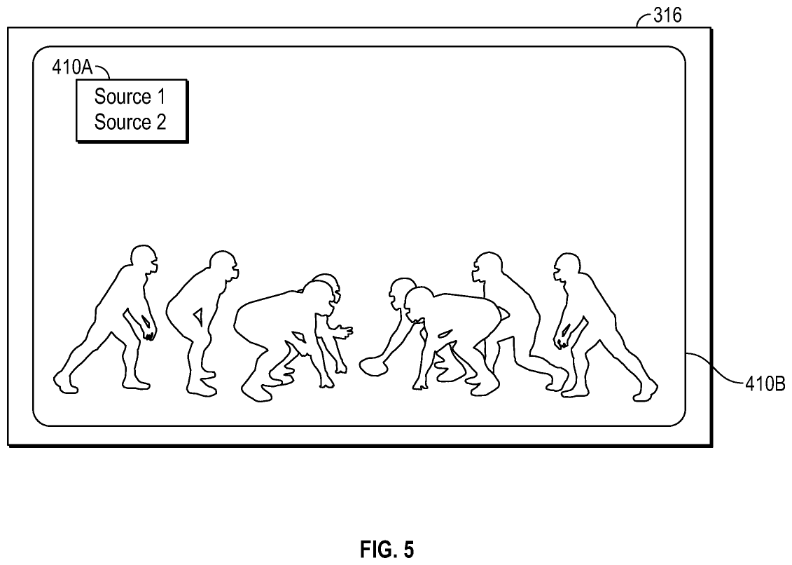

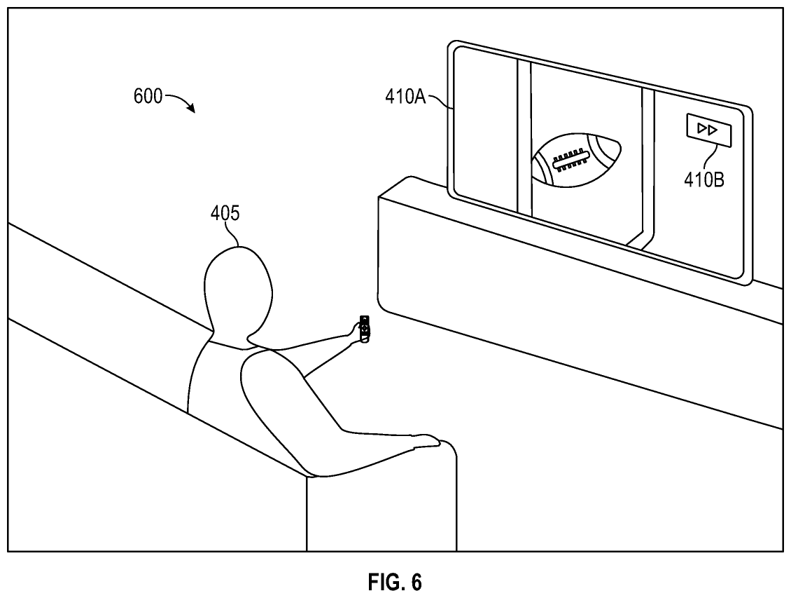

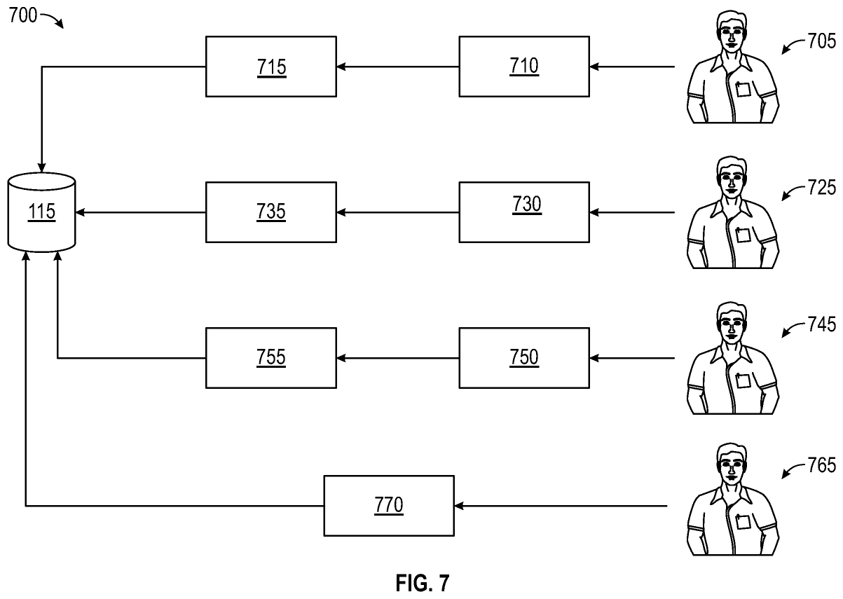

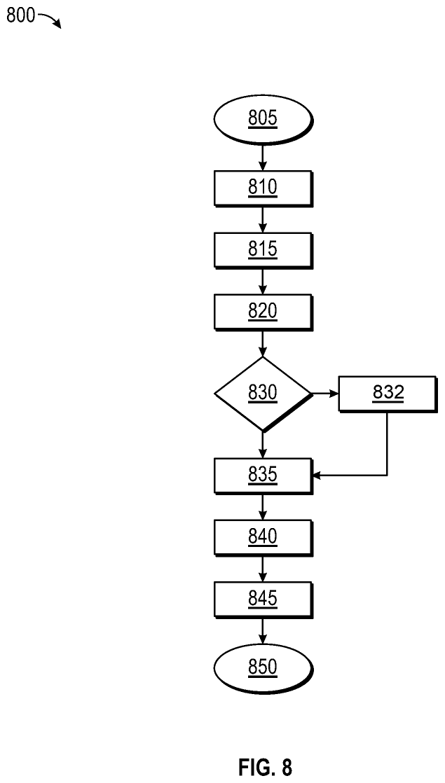

FIGS. 4-8 illustrate embodiments of a system 400 and method for seamlessly synching two or more multimedia sources. As illustrated in FIG. 4, the system 400 generally comprises a computing entity 200 in the form of a control board 200 having a user interface 410, a processor 220, a multimedia device 407 operably connected to said computing entity 200, a display 316 operably connected to said computing entity, and a non-transitory computer-readable medium 416 having instructions stored thereon. In one preferred embodiment, a database 115 may be operably connected to the processor 220 and store any combined multimedia source 425B created by the system within user profiles 425. The database 115 may also be used to store user data 425A, such as username, multimedia source preferences, etc. In some preferred embodiments, a wireless communication interface 280 may allow the processor 220 to receive audio data in the form of radio waves. In yet another preferred embodiment, the user interface 410 of the system may comprise a parent window 410A and a command window 410B. It is understood that the various method steps associated with the methods of the present disclosure may be carried out as operations by the system 400 shown in FIG. 4. FIG. 5 illustrates an example user interface 410, wherein the display 316 may receive said user interface 410 from the control board 200. FIG. 6 illustrates an environmental view 600 of the system being used by a user. FIG. 7 illustrates permission levels 700 that may be utilized by the present system 400 for controlling access to user content 715, 735, 755 such as combined multimedia sources 425B and user data 425A. FIG. 8 illustrates a method that may be carried out by the system 400.

As defined herein, a multimedia source is a communication containing audio data and/or video data and is located at a particular location on a network 150. A user 405 may access the communication by inputting an address coinciding with the communication's location within a user interface 410 of a computing device that allows the user 405 to access multimedia sources. In a preferred embodiment, as illustrated in FIG. 5, a multimedia device 407 may allow a user 405 to access a multimedia source. The multimedia device 407 may be connected to the control board 200 via a wired or wireless connection. In a preferred embodiment, the multimedia device 407 may be connected to the control board 200 via an input jack, such as an HDMI port. In some preferred embodiments, the system may connect to one or more multimedia devices 407 using one or more input jacks. For instance, the system may be connected to a first multimedia device 407 in a way such that it receives video data via a DVI cable and audio data via an optical cable. For instance, the system may be connected to a first multimedia device 407 via an HDMI cable and a second multimedia device 407 via a coax cable. This may allow the system 400 to receive video data and audio data from a plurality of sources so that a user 405 may create a combined multimedia source 425B. A primary multimedia source 421 preferably comprises both primary video data and primary audio data whereas a secondary multimedia source 422 comprises secondary audio data. However, other embodiments of a primary multimedia source 421 may comprise only one of a primary video data and primary audio data. And yet other embodiments may comprise a secondary multimedia source 422 with a secondary video data and secondary audio data. Therefore, the system may obtain multiple multimedia sources having various video data and audio data makeups without departing from the inventive subject matter described herein.

One preferred embodiment of the system 400 may comprise a database 115 operably connected to the processor 220. The database 115 may be configured to store combined multimedia sources 425B and user data 425A within user profiles 425. Combined multimedia sources 425B may be defined as a multimedia source created by the system by combining data from two or more sources. User data 425A may be defined as personal information of a user 405 such as user name, gender, and age. The database 115 may also be configured to store primary multimedia sources 422 and secondary multimedia sources 421, which the same may allow to be combined to create a combined multimedia source 425B at a later time. Alternatively, the processor 220 and/or database 115 may transmit video data and audio data to a server 110, which may then combine the video data and audio data in a way such that a combined multimedia source 425B is created. Once the server 110 has created the combined multimedia source 425B, it may transmit said combined multimedia source 425B back to the processor 220 so that it may be presented within the user interface 410 of the system 400. In a preferred embodiment, a user profile 425 is related to a particular user 405. A user 405 is preferably associated with a particular user profile 425 based on a user name. However, it is understood that a user 405 may be associated with a user profile 425 using a variety of methods without departing from the inventive subject matter herein.

The control board 200, as illustrated in FIG. 4 comprises at least one circuit and microchip. In another preferred embodiment, the control board 200 may further comprise a wireless communication interface 280, which may allow the control board 200 to receive instructions from an input device 408 controlled by a user 405. The control board 200 may regulate the combination of audio/video data from various multimedia sources to create a combined multimedia source 425B. The microchip of the control board 200 comprises a microprocessor 220 and memory. In another preferred embodiment, the microchip may further comprise a wireless communication interface 280 in the form of an antenna 420. The microprocessor 220 may be defined as a multipurpose, clock driven, register based, digital-integrated circuit which accepts binary data as input, processes it according to instructions stored in its memory, and provides results as output. In a preferred embodiment, the microprocessor 220 may receive a primary multimedia source 421 from a multimedia device 407 and a secondary multimedia source 422 via the antenna 420, wherein the primary multimedia source 421 comprises primary video data and primary audio data and the secondary multimedia source 422 comprises secondary audio data. The processor 220 may convert any secondary audio data received in the form of sound waves into digital data. In another preferred embodiment, the microprocessor 220 may receive a secondary multimedia source 422 from the communication interface 280 in the form of a live stream of a social media platform. In some preferred embodiments, a user 405 may select a live stream as a multimedia source via the user interface 410. For instance, a user 405 may choose to combine a first multimedia source from a streaming application of a streaming device and a live stream of a social media platform as the second multimedia source, wherein the live stream of the social media platform is related to the contents of the first multimedia stream.

In some preferred embodiments, the system may automatically separate primary video data and primary audio data from the primary multimedia source 421 and subsequently combine the primary video data with the secondary audio data to create the combined multimedia source 425B. Alternatively, the microprocessor 220 may receive instructions from an input device 408 via an antenna 420, which may instruct the microprocessor 220 as to which module to use, which may alter the multimedia source streamed to the user interface 410. For instance, a user 405 may choose “Original Audio Source” on the input device 408 to cause the system to stream the original primary multimedia source 421 to the user interface 410 without separating out the primary video data and primary audio data. For instance, a user 405 may select “Secondary Audio Source” within the command window 410B of the user interface 410 via the input device 408, which may cause the system to separate the primary video data and primary audio data from the primary multimedia source 421 and then combine the primary video data with the secondary audio data to create the combined multimedia source 425B. Ways in which the input device 408 may communicate with the control board 200 include, but are not limited, to near field communication (NFC), Bluetooth, infrared (IR), radio-frequency communication (RFC), radio-frequency identification (RFID), and ANT+, or any combination thereof. In one preferred embodiment, the control board 200 may be connected to the input via a wired connection.

As mentioned previously, the system 400 may further comprise a user interface 410. A user interface 410 may be defined as a space where interactions between a user 405 and the system 400 may take place. In an embodiment, the interactions may take place in a way such that a user 405 may control the operations of the system 400. A user interface 410 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 400 may present data of the user interface 410 to the user 405 via a display 316 operably connected to the processor 220. A display 316 may be defined as an output device 910 that communicates data that may include, but is not limited to, visual, auditory, cutaneous, kinesthetic, olfactory, and gustatory, or any combination thereof.

In a preferred embodiment, the display 316 receives the user interface 410 from the control board 200 and presents it to a user 405. The combined multimedia source 425B is streamed to a parent window 410A of the user interface 410. In another preferred embodiment, the user interface 410 may also comprise a command window 410B, wherein said command window 410B is nested within said parent window 410A. The processor 220 may manipulate the command window 410B based on commands received from an input device 408. The input device 408 may be connected to the system via a wired or wireless connection. In a preferred embodiment, the input device 408 communicates commands to the processor 220, which the processor 220 uses to manipulate the command window 410B. Indicia within the command window 410B may be used to indicate a module that will be executed by the processor 220. In a preferred embodiment, indicia used within the command window 410B indicate the multimedia sources the processor 220 has access. For instance, a user 405 may be required to login to a particular social media platform before having access to live streams of said social media platform. The system may use indicia to indicate which social media platforms have live streams related to a particular entertainment event as well as indicate if a user 405 currently has access to said live streams. In another preferred embodiment, indicia may be used to indicate which part of said multimedia source should be used to create the combined multimedia source 425B. For instance, a user 405 may manipulate the input device 408 in way that commands the processor 220 to select an indicia representing a module that will instruct the processor 220 as to how to combine the primary video data with the secondary audio data.

In one preferred embodiment, a user 405 may choose via the control interface a live stream as the primary multimedia source 421 and secondary multimedia source 422. In some preferred embodiments, a user 405 may choose more than one live stream and combine the live streams in the manners described above. For instance, a user 405 may select an official live stream of an Esports event as the primary multimedia source 421 and select a live stream of an Esports blogger as the secondary multimedia source 422 via the command window 410B using an input device 408. The user 405 may then be prompted to input any required credentials within the command window 410B so that the system may access said streams. The user 405 may also be prompted by the system to select which multimedia source will supply the video data and which multimedia source will supply the audio data. In this way a user 405 may choose to have the secondary multimedia source 422 to supply the video data and the primary multimedia source 421 supply the audio data, or vice versa. As such, the user interface 410 may be used in a plurality of ways by a user 405 to allow to control the ways in which multimedia sources are combined.

In yet another preferred embodiment, the user interface 410 may further comprise a communication window within the parent window, which may allow a user 405 to communicate with other users 405 of the system 410 or present information to users 405 about a particular event or events. For instance, a text chat related to an event viewed by the user 405 may be presented via the communication window as to allow the user 405 to interact with other users 405 of the system 400 also viewing said event. For instance, betting odds for sporting events may be presented via the communication window to provide live information regarding sports betting to a user 405. For instance, the communication window may be configured to receive social media posts related to a particular event and inform a user 405 of what other people may think about said particular event. In some preferred embodiments, permission levels may be used to allow or restrict user access to the communication window. For instance, the system 400 may be configured such that only paying users 405 may have the permissions that allow for use of the communication window. Alternatively, some embodiments of the system 400 may only allow users 405 to hide or unhide the communication window and/or choose a social media platform through which to receive information concerning an event. Therefore, the communication window may be used in multiple ways without departing from the inventive subject matter as described herein.

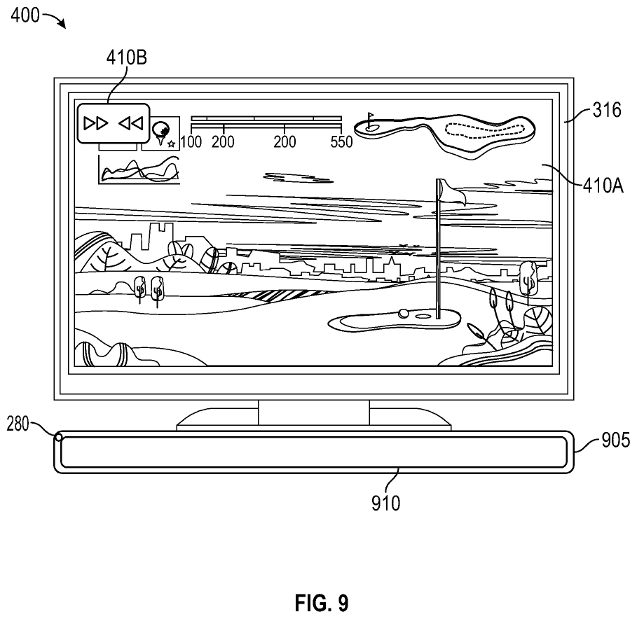

In one preferred embodiment, as illustrated in FIG. 9, the system may further comprise a case 905 and an output device 910 in the form of a speaker. The control board 200, speaker, and a non-transitory computer-readable medium 416 may be at least partially contained within the case 905. Audio data may be automatically routed by the control board 200 to the speaker whereas video data may be automatically transferred to a display 316 such as a television. Therefore, in some preferred embodiments, only the video data component of a combined multimedia source 425B is transmitted to the display 316. The video data component of a combined multimedia source 425B may be transferred to one or more displays 316 via a wired or wireless connection. In a preferred embodiment, an output jack may be used to transfer the video data component from the control board 200 within the case 905 to the display 316. In another preferred embodiment, a plurality of output devices 910 may be connected to the system. A user 405 may select one or more of the output devices 910 through which the audio data will be played via the command window 410B.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic suits, virtual reality headsets, speakers, and scent generating devices, or any combination thereof.

The system may buffer the audio data in a way such that the audio data and video data are synched with one another. In a preferred embodiment, a user 405 may input commands using the input device 408 which may cause the system to speed up or delay the sound timing and/or video timing until the audio data and video data are in synch. In another preferred embodiments, the system may use artificial intelligence (AI) techniques to synch audio data and video data. The term “artificial intelligence” and grammatical equivalents thereof are used herein to mean a method used by the system to correctly interpret and learn from data of the system or a fleet of systems in order to achieve specific goals and tasks through flexible adaptation. Types of AI that may be used by the system include, but are not limited to, machine learning, neural network, computer vision, or any combination thereof. The system preferably uses machine learning techniques to learn what events are taking place in the video data and correlating it with what is being expressed in the audio data, wherein the instructions carried out by the processor 220 for said machine learning techniques are stored on the CRM, server 110, and/or database 115. Machine learning techniques that may be used by the system include, but are not limited to, regression, classification, clustering, dimensionality reduction, ensemble, deep learning, transfer learning, reinforcement learning, or any combination thereof.

The system 100 may use more than one machine learning technique to synch audio data and video data to create a combined multimedia source 425B. For instance, the system may use a combination of natural language processing and reinforcement learning to discern what is being expressed in the audio data and deduce the events taking place in the video data. In some preferred embodiments, the may use machine learning techniques to deduce what is being expressed in the primary audio data and secondary audio data. Once the meaning of the contents of the primary audio data and secondary audio data have been determined, the system may adjust the speed of the secondary audio data such that what is expressed by the secondary audio data coalesce in time with what is expressed in the primary audio data, allowing the system to combine the buffered secondary audio data with the primary video data to create a combined multimedia source 425B having synched audio and video components. For instance, the system may take a sports broadcast from a television source and separate the video and audio components. The system may also take a radio broadcast of the same sports event and format the audio data into digital. Data. The system may then use natural language processing and deep learning to determine the contents of both the primary audio data and secondary audio data before deducing how far ahead or behind in time the secondary audio data is compared to the primary audio data. The processor 220 may then buffer the secondary audio data such that the events described in the primary audio data and secondary audio data coincide in time with one another, and then combine the secondary audio data with the primary video data to create a combined multimedia source 425B with synched audio data and video data.

To prevent un-authorized user 405 from accessing other user's 405 information, the system 400 may employ a security method. As illustrated in FIG. 7, the security method of the system 400 may comprise a plurality of permission levels 700 that may grant users 405 access to user content 715, 735, 755 within the database 115 while simultaneously denying users 405 without appropriate permission levels 700 the ability to view user content 715, 735, 755. To access the user content 715, 735, 755 stored within the database 115, users 405 may be required to make a request via a user interface 410. Access to the data within the database 115 may be granted or denied by the processor 220 based on verification of a requesting user's 705, 725, 745 permission level 700. If the requesting user's 705, 725, 745 permission level 700 is sufficient, the processor 220 may provide the requesting user 705, 725, 745 access to user content 715, 735, 755 stored within the database 115. Conversely, if the requesting user's 705, 725, 745 permission level 700 is insufficient, the processor 220 may deny the requesting user 705, 725, 745 access to user content 715, 735, 755 stored within the database 115. In an embodiment, permission levels 700 may be based on user roles 710, 730, 750 and administrator roles 770, as illustrated in FIG. 5. User roles 710, 730, 750 allow requesting users 705, 725, 745 to access user content 715, 735, 755 that a user 405 has uploaded and/or otherwise obtained through use of the system 400. Administrator roles 770 allow administrators 765 to access system 400 wide data.

In an embodiment, user roles 710, 730, 750 may be assigned to a user in a way such that a requesting user 705, 725, 745 may view user profiles 425 containing user data 425A and combined multimedia sources 425B via a user interface 410. To access the data within the database 115, a user 405 may make a user request via the user interface 410 to the processor 220. In an embodiment, the processor 220 may grant or deny the request based on the permission level 700 associated with the requesting user 705, 725, 745. Only users 405 having appropriate user roles 710, 730, 750 or administrator roles 770 may access the data within the user profiles 425. For instance, as illustrated in FIG. 5, requesting user 1 705 has permission to view user 1 content 715 and user 2 content 735 whereas requesting user 2 725 only has permission to view user 2 content 735. Alternatively, user content 715, 735, 755 may be restricted in a way such that a user may only view a limited amount of user content 715, 735, 755. For instance, requesting user 3 745 may be granted a permission level 700 that only allows them to view user 3 content 755 related to their specific financial institution but not user 3 content 755 related to other financial institutions. In the example illustrated in FIG. 5, an administrator 765 may bestow a new permission level 700 on users so that it may grant them greater permissions or lesser permissions. For instance, an administrator 765 may bestow a greater permission level 700 on other users so that they may view user 3's content 755 and/or any other user's 405 content 715, 735, 755. Therefore, the permission levels 700 of the system 400 may be assigned to users 405 in various ways without departing from the inventive subject matter described herein.

FIG. 8 provides a flow chart 800 illustrating certain, preferred method steps that may be used to carry out the method of combining multimedia sources to create a combined multimedia source 425B. Step 805 indicates the beginning of the method. During step 810, the processor may receive a primary multimedia source 421 from a computing entity. In a preferred embodiment, the primary multimedia source 421 is a digital telecommunication broadcast. Once the processor 220 has received the primary multimedia source 421, the processor 220 may separate the primary multimedia source 421 into primary video data and primary audio data during step 815. The processor 220 may then receive a secondary multimedia source 422 via the communication interface 280 during step 820. In a preferred embodiment, the secondary multimedia source 422 is in the form of a radio frequency broadcast. Once the processor 220 has received the secondary multimedia source 422, the processor 220 may perform a query to determine whether the secondary multimedia source 422 is in a digital format during step 825. The processor 220 may perform an action based on the results of that query during step 830. If the processor 220 determines that the secondary multimedia source 422 is not in a digital format, the processor 220 may convert the secondary multimedia source 422 into a digital format during step 832 before proceeding to step 835.

If the processor 220 determines that the secondary multimedia source 422 is in a digital format, the processor 220 may proceed to step 835 wherein the system may synch the primary video data with the secondary audio data of the secondary multimedia source 422. In a preferred embodiment, the system may synch the primary video data with the secondary audio data using commands received from an input device 408, wherein said commands instruct the processor 220 to speed up or delay the sound timing and/or video timing until the secondary audio data and primary video data are in synch. Alternatively, the system may us AI to synch the primary video data and secondary audio data. Once the audio data and video data have been synched, the system may combine the primary video data and secondary audio data to create a combined multimedia source 425B during step 840. The system may then stream the combined multimedia source 425B to the user interface 410 during step 845, wherein said user interface 410 is transmitted to a display 316 operably connected to the processor 220. Once the combined multimedia source 425B has been transmitted to the user interface 410, the method may proceed to the terminate method step 850.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for integrating a combining multimedia data, said system comprising:
a multimedia device configured to receive a first multimedia source containing primary video data and primary audio data,
a control board operably connected to said multimedia device,
wherein a processor of said control board is configured to receive said first multimedia source from said multimedia device,
wherein said processor of said control board is configured to receive a second multimedia source containing secondary audio data,
wherein said processor of said control board separates said primary video data and said primary audio data,
wherein said processor combines said primary video data and one of said primary audio data and secondary audio data to create a combined multimedia source,
wherein said processor streams said combined multimedia source within a parent window,
a communication interface operably connected to said control board,
wherein an input device transmits commands to said control board via said communication interface,
wherein said commands instruct said process as to how to combine said first multimedia source and said second multimedia source to create said combined multimedia source,
a display operably connected to said control board,
wherein said display receives said parent window, and
a non-transitory computer-readable medium coupled to said processor,
wherein said non-transitory computer-readable medium contains instructions stored thereon, which, when executed by said processor, cause said processor to perform operations comprising:
receiving said first multimedia source,
receiving said second multimedia source,
separating said primary video data and said primary audio data within said first multimedia source,
determining how to combine said primary video data, said primary audio data, and said secondary audio data,
creating said combined multimedia source,
streaming said combined multimedia source within said parent window,
transmitting said parent window to said display.

2. The system of claim 1, wherein said communication interface receives radio waves containing said secondary audio data.

3. The system of claim 2, wherein said processor converts said radio waves from an analog signal to a digital signal.

4. The system of claim 1, further comprising a database operably connected to said processor, wherein said database saves said combined multimedia source.

5. The system of claim 1, further comprising a command window integrated into said parent window.

6. The system of claim 5, wherein said commands cause said processor to manipulate said command window.

7. The system of claim 6, wherein instructions of said command window instruct said process as to how to combine said first multimedia source and said second multimedia source to create said combined multimedia source.

8. The system of claim 6, wherein said communication interface operably connects said processor to a network, wherein said processor receives secondary audio data over said network.

9. The system of claim 8, wherein said processor lists said secondary audio data within said command window.

10. The system of claim 9, wherein said input device is used to select one of said primary audio data and said secondary audio data within said command window, wherein selection of one of said primary audio data and secondary audio data will cause said processor to create said combined multimedia source.

11. A system for integrating a combining multimedia data, said system comprising:
a multimedia device configured to receive a first multimedia source containing primary video data and primary audio data,
a control board operably connected to said multimedia device,
wherein a processor of said control board is configured to receive said first multimedia source from said multimedia device,
wherein said processor of said control board is configured to receive a second multimedia source containing secondary audio data,
wherein said processor of said control board separates said primary video data and said primary audio data,
wherein said processor combines said primary video data and one of said primary audio data and secondary audio data to create a combined multimedia source,
a user interface having a parent window and command window,
wherein said processor streams said combined multimedia source within said parent window,
a display operably connected to said control board,
wherein said display receives said user interface, and
a non-transitory computer-readable medium coupled to said processor,
wherein said non-transitory computer-readable medium contains instructions stored thereon, which, when executed by said processor, cause said processor to perform operations comprising:
receiving said first multimedia source,
receiving said second multimedia source,
separating said primary video data and said primary audio data within said first multimedia source,
determining how to combine said primary video data, said primary audio data, and said secondary audio data,
creating said combined multimedia source,
streaming said combined multimedia source within said user interface,
transmitting said user interface to said display.

12. The system of claim 11, further comprising a database operably connected to said processor,
wherein said database saves said combined multimedia source.

13. The system of claim 11, wherein commands of an input device cause said processor to manipulate said command window.

14. The system of claim 13, wherein said processor lists said primary audio data and said secondary audio data within said command window.

15. The system of claim 11, wherein said commands cause said processor to select one of said primary audio data and secondary audio data.

16. A non-transitory computer-readable medium coupled to a processor,
wherein said non-transitory computer-readable medium contains instructions stored thereon, which, when executed by a processor, cause said processor to perform operations comprising:
receiving a first multimedia source,
receiving a second multimedia source,
separating primary video data and primary audio data within said first multimedia source,
separating secondary video data and secondary audio data within said second multimedia source,
choosing one of said primary video data and said secondary video data based on a module,
choosing one of said primary audio data and said secondary audio data based on said module,
combining chosen video data and chosen audio data to create a combined multimedia source,
streaming said combined multimedia source within a user interface,
transmitting said user interface to a display.

17. The system of claim 16, wherein said non-transitory computer-readable medium contains additional instructions, which, when executed by said processor, cause said processor to perform additional operations comprising:
saving said combined multimedia source within a database.

18. The system of claim 16, wherein said user interface comprises a parent window and a command window, wherein said command window is integrated into said parent window, wherein said combined multimedia source is streamed into said parent window.

19. The system of claim 18, wherein said non-transitory computer-readable medium contains additional instructions, which, when executed by said processor, cause said processor to perform additional operations comprising:
receiving commands from an input device,
manipulating said command window based on said commands, and
choosing said module based on said commands.

20. The system of claim 19, wherein said non-transitory computer-readable medium contains additional instructions, which, when executed by said processor, cause said processor to perform additional operations comprising:
hiding said command window when said commands have not been received for a specified time period,
revealing said command window after receiving said commands.
